(19) United States
(12) Patent Application Publication
(10) Pub. No.: US 2023/0384428 A1
(43) Pub. Date: Nov. 30, 2023

(54) LASER-SAFETY CONTROL FOR LIDAR APPLICATIONS

(71) Applicant: Sony Semiconductor Solutions Corporation, Kanagawa (JP)

(72) Inventor: Jianming Xu, San Jose, CA (US)

(21) Appl. No.: 17/752,115

(22) Filed: May 24, 2022

(51) Int. Cl. G01S 7/484; G01S 17/89; G01S 7/4861; G01S 7/481; G01S 17/10; G01S 7/497

(52) U.S. Cl. CPC G01S 7/484; G01S 17/89; G01S 7/4861; G01S 7/4817; G01S 17/10; G01S 7/497

(57) ABSTRACT

A lidar system capable of automatically adjusting the optical power of an optical-probe beam thereof based on scan-rate measurements and/or detection of a person within the system's field of view. In an example embodiment, the automatic power-adjustment capability includes a capability of turning OFF the corresponding laser source, e.g., when the scanning mirror has stalled. In various embodiments, the scan rate may continuously be monitored using suitably positioned photodiodes, a position-sensing photodetector, or a two-dimensional, pixelated light sensor configured to receive light reflected from the scanning mirror. Depending on the specific embodiment, the reflected light may include a small portion of the optical-probe-beam light or may be generated using a separate dedicated light source.

### BACKGROUND

### Field

Various example embodiments relate to remote sensing and, more specifically but not exclusively, to laser safety in light detection and ranging (lidar) applications.

### Description of the Related Art

This section introduces aspects that may help facilitate a better understanding of the disclosure. Accordingly, the statements of this section are to be read in this light and are not to be understood as admissions about what is in the prior art or what is not in the prior art.

Light detection and ranging, known as lidar, is a remote-sensing technique that can be used to measure a variety of parameters, such as distance, velocity, and vibration, and also for high-resolution imaging. Compared to radio-frequency (RF) remote sensing, lidar is capable of providing a finer range resolution and a higher spatial resolution due to the use of a higher carrier frequency and the ability to generate a smaller spot size at the foci. Lidar systems are used in urban planning, hydraulic and hydrologic modeling, geology, forestry, fisheries and wildlife management, three-dimensional (3D) imaging, engineering, coastal management, atmospheric science, meteorology, navigation, autonomous driving, robotic and drone operations, and other applications.

### SUMMARY OF SOME SPECIFIC EMBODIMENTS

Disclosed herein are various embodiments of a lidar system capable of automatically adjusting the optical power of an optical-probe beam thereof based on scan-rate measurements and/or detection of a person within the system's field of view. In an example embodiment, the automatic power-adjustment capability includes a capability of turning OFF the corresponding laser source, e.g., when the scanning mirror has stalled. In various embodiments, the scan rate may continuously be monitored using suitably positioned photodiodes, a position-sensing photodetector, or a two-dimensional, pixelated light sensor configured to receive light reflected from the scanning mirror. Depending on the specific embodiment, the reflected light may include a small portion of the optical-probe-beam light or may be generated using a separate dedicated light source. The system's electronic controller may be programmed to control operations of the lidar system based on the scan-rate and optical-power measurements and in accordance with the ANSI Z136.1 standard and/or other selected laser-safety constraints.

According to an example embodiment, provided is an apparatus, comprising: a lidar transmitter including a laser source to generate an optical-probe beam and a movable mirror to scan the optical-probe beam across a field of view (FOV); an optical monitor configured to generate a stream of measurements of a scan rate of the optical-probe beam by optically sensing motion of the movable mirror; and an electronic controller configured to cause dynamic changes of optical power of the optical-probe beam in response to the stream of measurements of the scan rate.

In some embodiments of the above apparatus, the apparatus further comprises a lidar receiver to receive an optical signal produced by reflections of the optical-probe beam from a scene in the FOV. The electronic controller is configured to cause the lidar transmitter to dynamically change the optical power of the optical-probe beam such that maximum permissible exposure (MPE) for a person in the scene is not exceeded.

In some embodiments of any of the above apparatus, the lidar transmitter includes circuitry configured to drive the laser source and further configured to drive the movable mirror. The circuitry is further configured to communicate to the electronic controller one or more performance indicators internally generated by the circuitry while driving the laser source and the movable mirror.

In some embodiments of any of the above apparatus, the apparatus further comprises a camera configured to capture an image of a scene in the FOV. The electronic controller is configured to determine whether or not a person is present in the scene by processing the image and is further configured to cause the dynamic changes based on a determination outcome.

According to another example embodiment, provided is a method of operating a lidar transmitter, the method comprising the steps of: scanning an optical-probe beam across the FOV of the lidar transmitter by operating a laser source and a movable mirror, the laser source being configured to apply the optical beam to the movable mirror; generating a stream of measurements of a scan rate of the optical-probe beam by optically sensing motion of the movable mirror; and dynamically changing optical power of the optical-probe beam in response to the stream of measurements of the scan rate by operating an electronic controller connected to the laser source.

In some embodiments of the above method, the method further comprises the steps of: operating circuitry configured to drive the laser source and the movable mirror, the operating including the circuitry internally generating one or more performance indicators while driving the laser source and the movable mirror and externally communicating the one or more performance indicators to the electronic controller; and operating a camera to capture an image of a scene in the FOV; and determining whether or not a person is present in the scene by automatically processing the image.

In some embodiments of any of the above methods, the step of dynamically changing is performed further in response to the one or more performance indicators and based on a result of the determining.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 is a block diagram illustrating a lidar environment, including a lidar system in which various embodiments may be practiced;

FIG. 2 is a block diagram illustrating an optical device that can be used in the lidar system of FIG. 1 according to an embodiment;

FIGS. 3A-3C pictorially illustrate example optical-beam scan patterns that can be realized in the optical device of FIG. 2 according to an embodiment;

FIGS. 4A-4E schematically illustrate several example embodiments of a light detector that can be used in the optical device of FIG. 2;

FIGS. 5A-5B show schematic diagrams illustrating the optical device of FIG. 2 according to another embodiment;

FIG. 6 is a block diagram illustrating an electrical circuit that can be used in the lidar system of FIG. 1 according to an embodiment;

FIG. 7 is a timing diagram illustrating operation of the electrical circuit of FIG. 6 according to an embodiment;

FIG. 8 is a flowchart illustrating a method of operating the lidar system of FIG. 1 according to an embodiment;

FIG. 9 is a flowchart illustrating a method of operating the lidar system of FIG. 1 according to another embodiment; and

FIG. 10 is a block diagram illustrating a lidar system according to another embodiment.

### DETAILED DESCRIPTION

Some embodiments may benefit from at least some features disclosed in U.S. patent application Ser. No. 17/363,643, which is incorporated herein by reference in its entirety.

Maximum Permissible Exposure (MPE) is the irradiance or radiant exposure that may be incident upon an eye (or the skin) of a person without causing an adverse biological affect. The MPE varies by wavelength and duration of exposure and is documented in the tables published under the ANSI Z136.1 standard, which is incorporated herein by reference in its entirety. MPE values may typically be treated as a design criterion for laser-safety control systems.

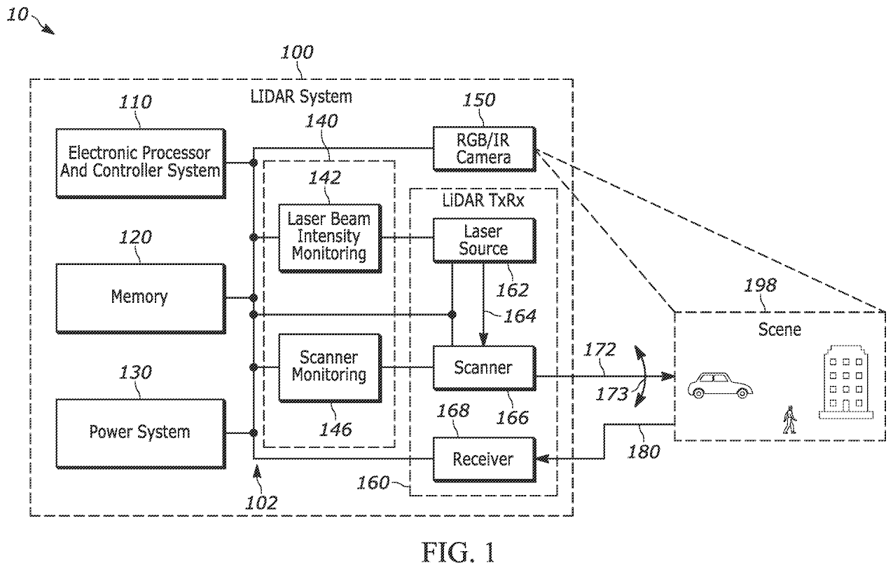

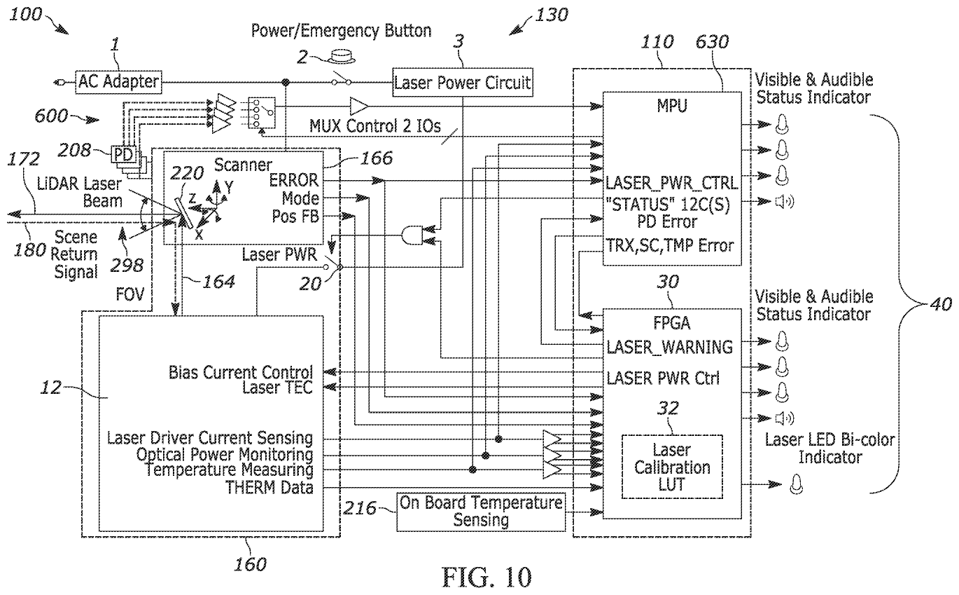

FIG. 1 is a block diagram illustrating a lidar environment 10 according to various embodiments. In the shown example, lidar environment 10 includes a lidar system 100 and a scene 198. Lidar system 100 comprises an electronic controller 110, a memory 120, a power system 130, an optical monitor 140, a camera 150, and a lidar transceiver (TxRx) 160. Electronic controller 110 typically includes a processor (not explicitly shown in FIG. 1, e.g., see FIG. 10). In different embodiments, lidar system 100 may include more or fewer components/elements compared to the number of components/elements explicitly shown in FIG. 1. Also, lidar system 100 may perform additional functions compared to the functionality described herein below. In some embodiments, some of the functionality of lidar system 100 may be at least partly incorporated into a server or other electronic devices (not explicitly shown in FIG. 1) connected thereto. As illustrated in FIG. 1, different components of lidar system 100 are electrically connected to each other by way of one or more control and/or data buses 102 to enable communications between different components.

Lidar transceiver 160 comprises a lidar (optical) transmitter, including laser source 162 and an optical scanner 166, and a lidar (optical) receiver 168. Laser source 162 operates to generate an optical-probe beam 164 that is redirected, by optical scanner 166, as optical-probe beam 172, toward scene 198. Depending on the intended application, lidar system 100 may have one or more lenses (not explicitly shown in FIG. 1) arranged to form an optical collimator, an objective, and/or a telescope. A corresponding optical signal 180 generated by reflections of optical-probe beam 172 from scene 198 is captured by the lens system of transceiver 100 and applied to lidar receiver 168. Lidar receiver 168 operates to convert the received optical signal 180 into electrical form and applies the resulting electrical signal to a processor, e.g., 110, for processing. Optical scanner 162 operates to optically scan scene 198 by moving the light spot of optical-probe beam 172 across the scene 198 within the field of view lidar transceiver 160, e.g., as schematically indicated in FIG. 1 by a double-headed arrow 173. Depending on the embodiment, optical-probe beam 164, 172 may be in the form of a continuous-wave (CW) optical beam or a pulsed optical beam. The optical-probe beam 164, 172 may have a fixed carrier frequency or may be frequency-chirped. The carrier frequency can be in the ultraviolet, visible, near infrared, or infrared part of the optical spectrum.

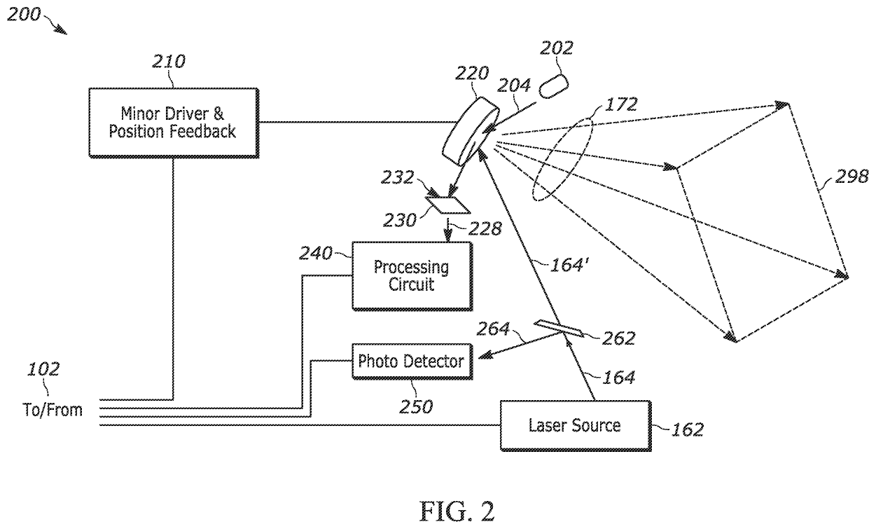

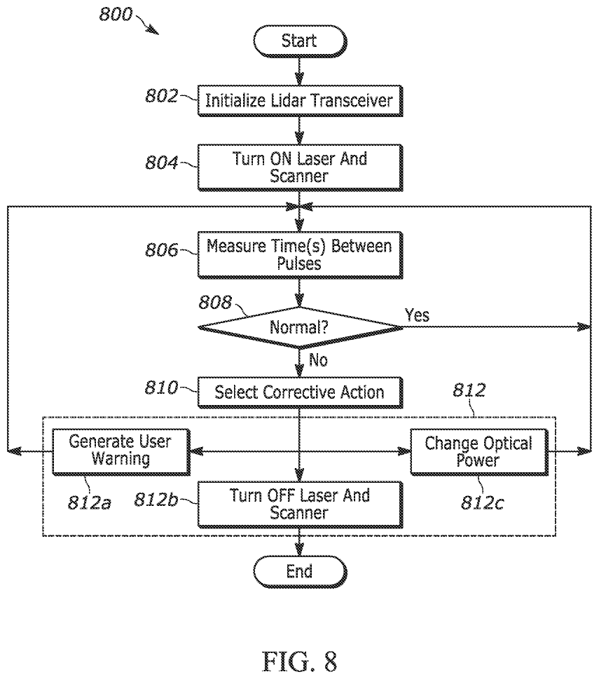

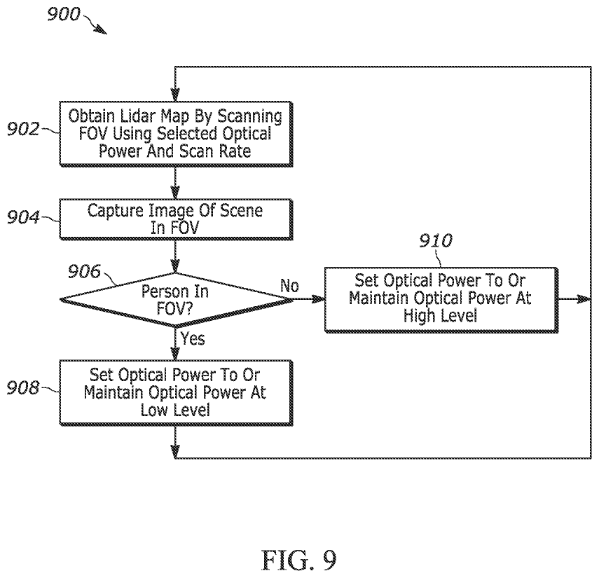

In an example embodiment, optical monitor 140 includes an intensity monitor 142 and a scanner monitor 146. Intensity monitor 142 is configured to measure the intensity (optical power) of one or both of optical-probe beams 164 and 172. Scanner monitor 146 is configured to monitor the operability of scanner 166. The measurement/monitoring results generated by intensity monitor 142 and scanner monitor 146 are directed, via bus 102, to controller 110 and are processed therein to monitor substantial MPE compliance and, if needed, to implement configuration changes directed at achieving substantial MPE compliance for lidar system 100. Example embodiments of intensity monitor 142 and scanner monitor 146 are described in more detail below in reference to FIGS. 2-7. Example embodiments of a control method that may be executed using controller 110 to perform configuration changes in lidar system 100 are described in more detail below in reference to FIG. 8-9.

In various other embodiments, lidar system 100 may have a plurality of lidar transceivers 160 and/or a plurality of optical monitors 140.

Camera 150 may be used to acquire images of scene 198. The image acquisition may be synchronized with the lidar frames, e.g., such that the camera captures at least one image of scene 198 per one complete scan of the scene performed by scanner 166. For example, in some embodiments, camera 150 may be operated at a higher frame rate than the lidar frame rate, with the frame-rate ratio being a positive integer greater than one. The images captured by camera 150 may be directed, via bus 102, to controller 110 and can be processed therein, in conjunction with the measurement/monitoring results generated by intensity monitor 142 and scanner monitor 146, to further the ability of the controller to implement appropriate configuration changes, e.g., as described in more detail below in reference to FIGS. 8-9. In some embodiments, camera 150 is optional and, as such, may be absent.

FIG. 2 is a block diagram illustrating an optical device 200 that can be used in lidar system 100 according to an embodiment. Optical device 200 can be used, e.g., to implement parts of optical monitor 140 and lidar transceiver 160 (also see FIG. 1). For example, optical device 200 includes laser source 162. Various components of optical device 200 may be connected to bus 102 of lidar system 100 as indicated in FIG. 2 (also see FIG. 1).

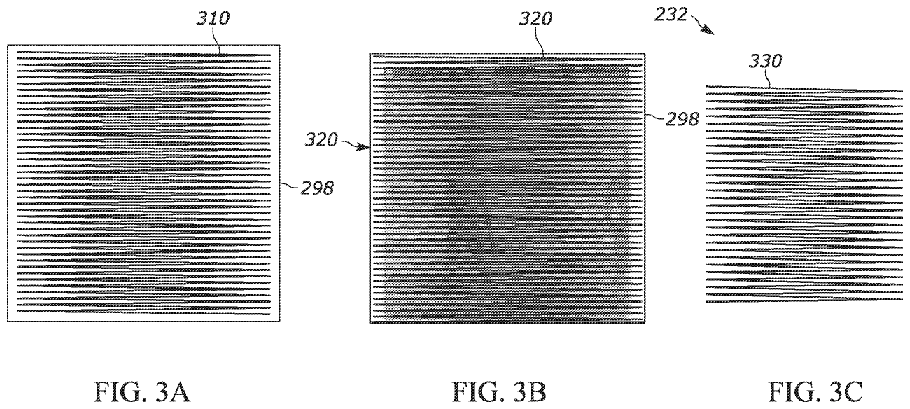

Optical device 200 comprises a movable mirror 220 configured to receive optical-probe beam 164′ from laser source 162 and to scan the corresponding redirected optical-probe beam 172 across a field of view (FOV) 298 along a suitable scan path or pattern (see, e.g., FIGS. 3A-3B). In various embodiments, mirror 220 may be implemented using a MEMS mirror, an opto-mechanical scanner, or other suitable optical-beam deflector. The orientation of mirror 220 can be changed using a mirror-driver circuit 210. In operation, circuit 210 may apply a suitable time-dependent drive signal (e.g., voltage) to mirror 220 to drive the mirror to move, thereby moving optical-probe beam 172 along the corresponding scan path/pattern within FOV 298. A fixed, partially transparent mirror 262 located between laser source 162 and mirror 220 operates to branch off a small portion 264 of optical beam 164 to a photodetector 250. The transmitted portion of optical beam 164 forms optical beam 164′. The electrical signal generated by photodetector 250 in response to optical beam 264 thus provides a measure of the intensity of optical-probe beam 164. In an example embodiment, optical beam 264 may carry, e.g., less than ca. 5% of the optical power of optical-probe beam 164. In another example embodiment, optical beam 264 may carry less than ca. 1%, e.g., approximately 0.1%, of the optical power of optical-probe beam 164.

In various other embodiments, other or alternative optical elements may be used to accomplish laser-light pickup for monitoring purposes. For example, in some embodiments, mirror 262 may be absent, and mirror 220 may be coated with a coating providing partial reflection and partial transmission of the incident light of optical beam 164′. In some such embodiments, the coating may provide ca. 99.9% reflection and ca. 0.1% transmission of the incident optical power. Photodetector 250 may be placed at the backside of mirror 220 to receive the transmitted light, thereby providing a measure of the optical power of optical-probe beam 164′.

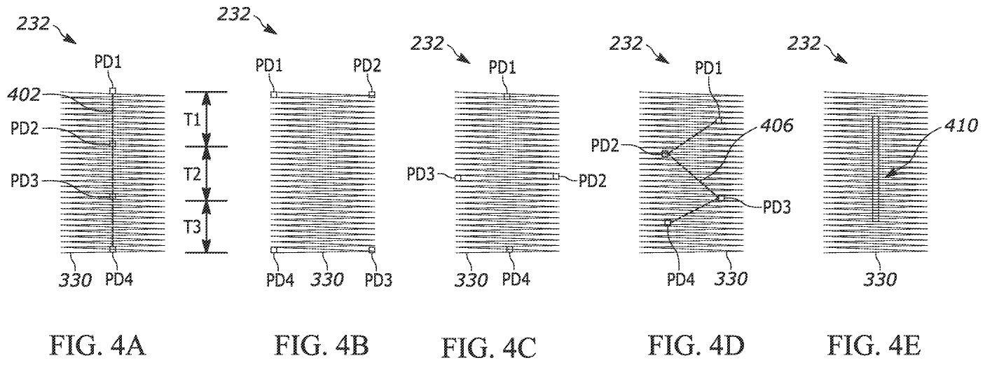

Optical device 200 further comprises a second light source 202 configured to direct a second optical beam 204 to mirror 220. In an example embodiment, light source 202 can be implemented using a light-emitting diode (LED) or another suitable light source operating at a significantly lower output power than laser source 162. In particular, the optical output power of light source 202 may be significantly lower than a safety threshold value specified in pertinent lidar and/or laser safety regulations. Upon being reflected by mirror 220, optical beam 204 impinges on a plane 232 of a light detector 230. An electrical output 228 generated by light detector 230 is applied to a processing (e.g., logic) circuit 240 connected thereto. Processing circuit 240 operates to process the electrical output 228 to obtain indications of the operating status of optical scanner 166 in general and movable mirror 220 in particular. Several example embodiments of light detector 230 are described in more detail below in reference to FIGS. 4A-4E.

FIGS. 3A-3C pictorially illustrate example optical-beam scan patterns that can be realized in optical device 200 according to an embodiment. More specifically, FIG. 3A illustrates an example beam-scan pattern 310 that may be generated by lidar transceiver 160 within FOV 298 (also see FIG. 2). Pattern 310 is an example of a raster pattern, wherein optical-probe beam 172 sweeps across FOV 298 horizontally and vertically at a steady rate. Other suitable scan patterns of FOV 298 may similarly be used and controlled by way of electronic controller 110. FIG. 3B additionally shows an example scene view 320 that may be present within the field of view 298 of FIG. 3A. Scene view 320 corresponds to an example scene 198 (also see FIG. 1).

FIG. 3C illustrates an example beam-scan pattern 330 within plane 232 of light detector 230 (also see FIG. 2). More specifically, pattern 330 is the pattern that optical beam 204 reflected by mirror 220 follows within the plane 232 when optical-probe beam 172 moves along pattern 310 (FIG. 3A). In an example embodiment, light detector 230 may have one or more photodetectors within PD plane 232, e.g., as explained below in reference to FIGS. 4A-4E. In one possible embodiment, plane 232 may have a two-dimensional, pixelated light sensor, e.g., similar to a pixelated light sensor that may be used in a conventional, low-resolution digital photo camera. Such a pixilated light sensor can be used to track the beam-scan pattern 330 within plane 232 at the spatial resolution of the pixilated light sensor.

FIGS. 4A-4E schematically illustrate several example embodiments of light detector 230. In the embodiments illustrated in FIGS. 4A-4D, light detector 230 includes four photodiodes, labeled PD1-PD4, variously located within PD plane 232. In the embodiment illustrated in FIG. 4E, light detector 230 includes a stripe-shaped, position-sensing photodetector 410.

Referring to FIG. 4A, in this particular embodiment, photodiodes PD1-PD4 are placed equidistantly on a straight line 402 in a middle portion of plane 232. More specifically, photodiodes PD1 and PD4 are placed at the upper and lower boundaries, respectively, of a rectangle swept by scan pattern 330. Photodiodes PD2 and PD3 are placed between photodiodes PD1 and PD4 on the straight line 402 to produce the intended equidistant photodiode arrangement.

In operation, optical beam 204 follows scan pattern 330 within plane 232, thereby hitting different photodiodes PD1-PD4 at different respective times. Without any scanner malfunction, the time differences, T1, T2, and T3, between the times at which two consecutive photodiodes are hit by optical beam 204 are expected to be the same, i.e., T1=T2=T3. In contrast, any significant deviation from this relationship may typically indicate some malfunction in the operation of optical scanner 166. Such deviations can be detected, e.g., by processing the corresponding output signal(s) 228 in processing circuit 240.

The embodiments illustrated in FIGS. 4B-4D are based on a similar principle and differ from the embodiment of FIG. 4A primarily in the positions of the photodiodes PD1-PD4 within PD plane 232. More specifically, in the embodiment of FIG. 4B, photodiodes PD1-PD4 are placed at the corners of the rectangle swept by scan pattern 330. In the embodiment of FIG. 4C, photodiodes PD1-PD4 are placed in the middle of each side of the rectangle swept by scan pattern 330. In the embodiment of FIG. 4D, photodiodes PD1-PD4 are placed on a zigzag line 406 within the rectangle swept by scan pattern 330, as indicated in FIG. 4D. In each of these photodiode arrangements, without any scanner malfunction, the time differences between the times at which two consecutive photodiodes are hit by optical beam 204 are expected to have certain fixed values. Any significant deviation from this relationship, as detected by processing circuit 240, may be indicative of a malfunction.

Referring to FIG. 4E, linear position-sensing photodetector 410 operates to generate an electrical pulse upon each crossing thereof by optical beam 204. Since scan pattern 330 crosses photodetector 410 multiple times, the expected photodetector output includes a sequence of electrical pulses. The exact number of pulses in the sequence depends on the length of photodetector 410 and the longitudinal pitch of scan pattern 330. Any significant deviations from the expected timing of the electrical pulses, as detected by processing circuit 240, may typically be indicative of a malfunction.

In various alternative embodiments, other photodiode arrangements may also be used. For example, other placements of photodiodes PD1-PD4 are possible. The number of photodiodes is not limited to four and can be smaller or larger than four. Various types of photodetectors may be used, e.g., photodiodes, phototransistors, avalanche photodiodes, variously shaped one-dimensional (1D) light-detector arrays, 2D area-sensing arrays, or image sensor devices, such as CCD or CMOS image sensors.

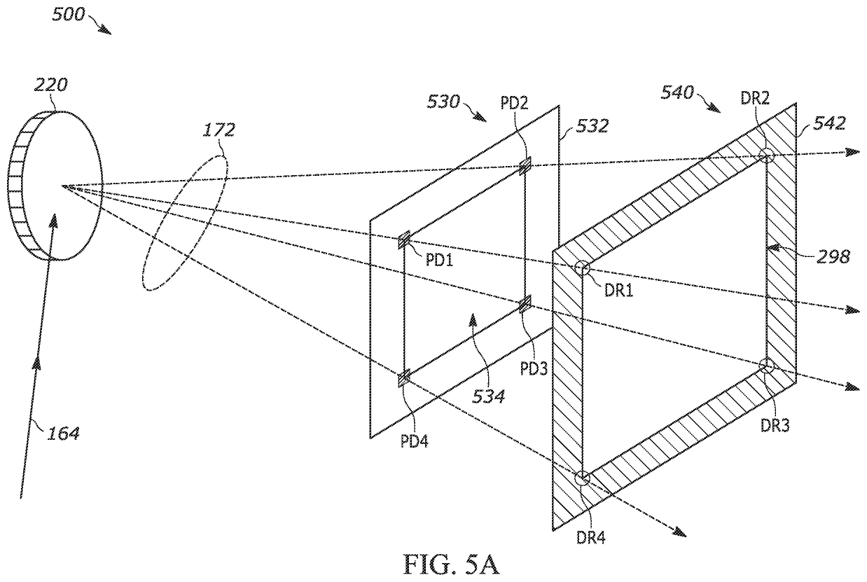

FIGS. 5A-5B show schematic diagrams illustrating optical device 200 (FIG. 2) according to another embodiment. More specifically, FIG. 5A is a schematic diagram illustrating a portion 500 of such optical device 200. FIG. 5B is a plan view of an optical output window 540 of scanner 166 (FIG. 1).

In this particular embodiment of optical device 200, second light source 202 is absent, and light detector 230 is replaced by a light detector 530 positioned as indicated in FIG. 5A. Light detector 530 includes photodiodes PD1-PD4 mounted on a printed circuit board (PCB) 532 and connected to processing circuit 240 as described above. PCB 532 has a rectangular opening 534 through which optical-probe beam 172 can be directed toward optical output window 540 and further toward scene 198. Optical output window 540 is defined by a frame 542 and has a shape generally corresponding to FOV 298 (also see FIG. 2).

Photodiodes PD1-PD4 are mounted on the side of PCB 532 that is facing optical output window 540, e.g., near the corners of rectangular opening 534, as indicated in FIG. 5A. Frame 542 has small diffuser reflectors DR1-DR4 mounted on the side thereof facing PCB 530, e.g., near the corners of window 540, as further indicated in FIG. 5A. In alternative embodiments, other suitable placements of photodiodes PD1-PD4 on PCB 532 and diffuser reflectors DR1-DR4 on frame 542 are also possible.

In operation, in response to the incident optical-probe beam 172, each of diffuser reflectors DR1-DR4 produces a respective cone of diffusely reflected light directed toward light detector 530. Each of the respective cones of diffusely reflected light is sufficiently narrow to substantially impinge only onto respective one of photodiodes PD1-PD4 and not onto the other three photodiodes. More specifically, diffuser reflector DR1 produces a cone of light that impinges substantially only onto photodiode PD1. Diffuser reflector DR2 produces a cone of light that impinges substantially only onto photodiode PD2. Diffuser reflector DR3 produces a cone of light that impinges substantially only onto photodiode PD3. Diffuser reflector DR4 produces a cone of light that impinges substantially only onto photodiode PD4. When optical-probe beam 172 is scanned across FOV 298 as indicated in FIG. 5B, the resulting cones of diffusely reflected light sequentially hit photodiodes PD1-PD4 of light detector 530 (FIG. 5A), thereby causing the photodiodes to generate corresponding electrical pulses at the hit times. Without any scanner malfunction, the time differences between two consecutive electrical pulses are expected to have certain fixed values. Any significant deviation from the expected timing of the electrical pulses, as detected by processing circuit 240, may be indicative of a scanner malfunction.

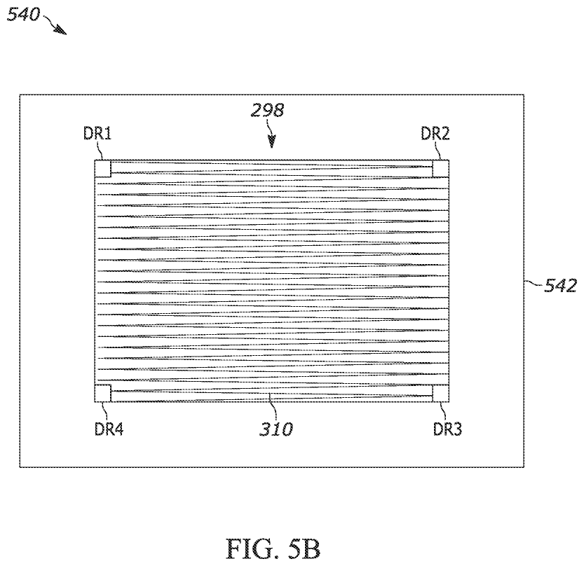

FIG. 6 is a block diagram illustrating a circuit 600 that can be used in lidar system 100 according to an embodiment. In different implementations of circuit 600, various components thereof may be differently distributed within lidar system 100. For example, photodiodes PD1-PD4 of circuit 600 may be located in light detector 230 (FIG. 2) or in light detector 530 (FIG. 5A). In some embodiments, a portion of circuit 600 may be located on PCB 532. In some embodiments, a portion of circuit 600 may be a part of processing circuit 240 and/or electronic controller 110.

Each of photodiodes PD1-PD4 of circuit 600 is connected to a respective one of transimpedance amplifiers TIA1-TIA4, the outputs of which are connected to a 4×1 analog switch 610. The channel selection for switch 610 is controlled by a 2-bit control signal IO provided by a microprocessor unit (MPU) 630. MPU 630 is connected to: (i) receive a synchronization signal SCAN_SYNC; (ii) control, via a control signal 628, the settings of an amplifier circuit 620; and (iii) receive an output signal 622 generated by amplifier circuit 620 in response to an output signal 612 of switch 610 and digitize and process the received signals.

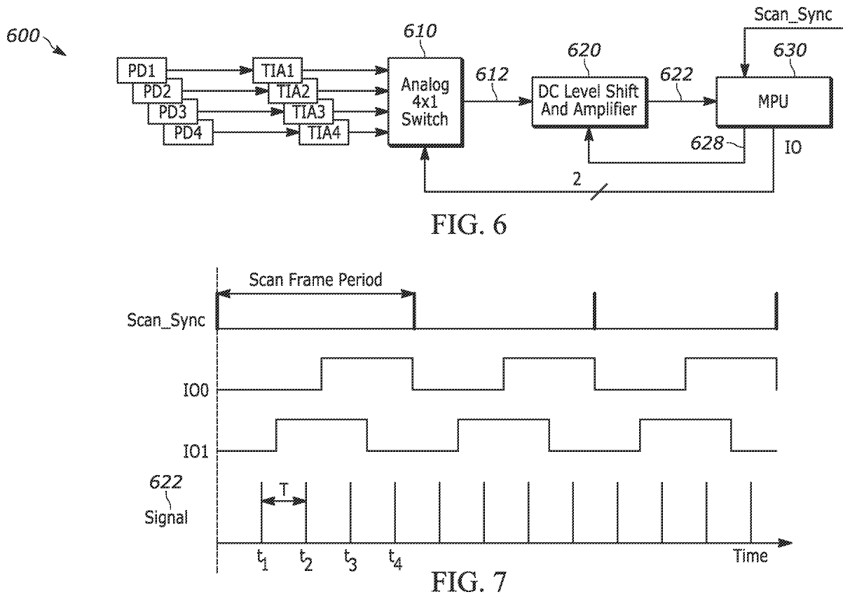

FIG. 7 is a timing diagram illustrating operation of circuit 600 according to an embodiment. More specifically, the signal traces of FIG. 7 correspond to an embodiment in which photodiodes PD1-PD4 are placed such that, in response to the optical-probe beam 172 being scanned across FOV 298, the photodiodes collectively generate a periodic pulse sequence exemplified by output signal 622 illustrated by the bottommost waveform in FIG. 7. An example of such an embodiment is described above in reference to FIG. 4A.

The topmost waveform of FIG. 7 illustrates frame synchronization signal SCAN_SYNC (also see FIG. 6). Signal SCAN_SYNC comprises a periodic pulse sequence, wherein each pulse corresponds to a new lidar frame, e.g., one full scan of FOV 298 as illustrated in FIG. 3A. The next two waveforms of FIG. 7, labeled IO0 and IO1, respectively, illustrate the time dependence of the two bits of control signal IO (also see FIG. 6). Each of signals IO0 and IO1 is a binary, rectangular-pulse waveform with a duty cycle of 0.5. The two waveforms are phase-shifted with respect to one another by one half of the frame period.

At time t1, the binary value provided by signals IO0, IO1 is 00. In response to this binary value, switch 610 selects the output of photodiode PD1. At time t2, the binary value provided by signals IO0, IO1 is 01. In response to this binary value, switch 610 selects the output of photodiode PD2. At time t3, the binary value provided by signals IO0, IO1 is 11. In response to this binary value, switch 610 selects the output of photodiode PD3. At time t4, the binary value provided by signals IO0, IO1 is 10. In response to this binary value, switch 610 selects the output of photodiode PD4. This sequence is continuously repeated, thereby producing the periodic pulse sequence illustrated by the bottommost waveform in FIG. 7. The period T of this pulse sequence is one quarter of the frame period. Any irregularities in electrical signal 622, as may be detected by processing circuit 240, are typically indicative of an optical-scanner malfunction in this particular embodiment.

FIG. 8 is a flowchart illustrating a method 800 of operating lidar transceiver 160 according to an embodiment. Method 800 can be used, e.g., to ensure operational compliance of lidar transceiver 160 with MPE requirements of the above-cited ANSI Z136.1 standard. For illustration purposes and without any implied limitations, method 800 is described in reference to an embodiment of lidar system 100 employing circuit 600 (also see FIGS. 6-7, 10).

Method 800 includes initializing lidar transceiver 160 (in block 802). Such initialization may include, e.g., specifying the frame rate for lidar transceiver 160, the angular scan rate for scanner 166, the optical power and output wavelength for laser source 162, and other applicable configuration parameters. In an example embodiment, the initialization may include retrieving a pertinent configuration file from memory 120 and using electronic controller 110 to generate the corresponding appropriate control signals for various system components.

Method 800 also includes starting laser source 162 and starting optical scanner 166 (in block 804). When started, laser source 162 may operate to generate (in block 804) optical-probe beam 164 having the optical power and wavelength as initialized in block 802. Scanner 166 may operate to steer (in block 804) optical-probe beam 172 according to the frame rate and angular scan rate, as initialized in block 802.

Method 800 also includes monitoring the operation of optical scanner 166 (in block 806). Such monitoring may include measuring (in block 806) a sequence of electrical pulses generated by light detector 230 or 530. For example, such measuring may include measuring time intervals between electrical pulses in signal 622 (FIG. 6). As already explained above, in this particular embodiment, signal 622 carries a periodic pulse sequence during normal operation, e.g., as illustrated in FIG. 7. Any significant deviations from the expected pulse timing may usually be indicative of a scanner malfunction.

Method 800 also includes analyzing (in block 808) the monitoring results obtained in block 806 to determine whether or not optical scanner 166 is operating normally. If it is determined (in block 808) that scanner 166 is operating normally, then no additional action is taken by electronic controller 110. If it is determined (in block 808) that optical scanner 166 is not operating normally, then electronic controller 110 may select (in block 810) one or more suitable corrective actions from a set of predetermined actions. The action(s) selected by electronic controller 110 may typically depend on the type and extent of deviations from the expected timing of electrical pulses. For illustration purposes and without any implied limitations, the set of predetermined actions shown in FIG. 8 includes three possible actions, labeled 812a, 812b, and 812c, respectively. In other embodiments, a different number of actions and/or other actions may be included in the set of predetermined actions.

Method 800 also includes the controller 110 executing (in block 812) the one or more actions selected in block 810. For example, if the time duration T between PD pulses in signal 622 (FIG. 7) exceeds a first fixed threshold value, T₁, then laser source 162 may be turned off by action 812b. One example of such behavior may be due to the mirror 220 being “stuck” in a fixed position, i.e., not moving. In this case, beam 172 is projected onto a fixed area of scene 198, which may be dangerous in some situations. If the time duration T between electrical pulses in signal 622 (FIG. 7) is between a second fixed threshold value, T₂, and the first threshold value, e.g., T₀<T₂<T<T₁, then the optical power of laser source 162 may be reduced by action 812c. Herein, To denotes the expected period of the pulse sequence of signal 622. If the time duration T between PD pulses in signal 622 (FIG. 7) is smaller than the second fixed threshold value but is outside the fixed tolerance interval ΔT around T₀, then a warning for the user may be generated by way of action 812a. In an example embodiment, the values of T₁, T₂, and ΔT may be selected to satisfy the safety criteria derived from the MPE requirements of the above-cited ANSI Z136.1 standard and/or in accordance with the scan-mirror sweep speeds, horizontally and vertically.

FIG. 9 is a flowchart illustrating a method 900 of operating system 100 according to an embodiment. This particular embodiment uses images of scene 198 acquired by camera 150 while lidar transceiver 160 is scanning FOV 298. Controller 110 may be used to perform image processing to determine whether or not a living object (e.g., a person) is present in FOV 298, e.g., as described in the above-cited U.S. patent application Ser. No. 17/363,643.

Method 900 includes the lidar transceiver 160 scanning FOV 298 (in block 902) using the selected frame and scan rates and further using a desired optical power P of optical-probe beam 172. Initially, the optical power P may be at an initial level, as initialized in block 802 (FIG. 8). In the course of method 900, the optical power P may be changed in blocks 908 and 910 as described below. The optical power P of optical-probe beam 172 can be measured and monitored, e.g., using photodetector 250 (FIG. 2). Using method 900, the optical power P of optical-probe beam 172 may be dynamically adjusted based on the contents of scene 198.

Method 900 also includes the camera 150 capturing an image (in block 904) of scene 198, which is in the FOV 298 that is being scanned in block 902. Depending on the embodiment, the captured image may be a color image, a grayscale image, or an infrared image. The resolution of the captured image may be the same as or different from the resolution of the lidar map obtained in block 902.

Method 900 also includes the controller 110 processing (in block 906) the image captured in block 904 to determine whether or not a person is present in the FOV 298. Depending on the determination result, a power-setting action of block 908 or a power-setting action of block 910 may be taken.

Method 900 also includes the controller 110 setting or maintaining (in block 908) the optical power P of optical-probe beam 172 at a relatively low level. Said low level may be selected such as to meet the MPE requirements of the above-cited ANSI Z136.1 standard. In this manner, the risk of injury to the person(s) present in scene 198 may be minimized After the optical power is set in block 908, method 900 may continue to block 902.

Method 900 also includes the controller 110 setting or maintaining (in block 910) the optical power P of optical-probe beam 172 at a relatively high level. Said high level may be selected such as to optimize (e.g., maximize) the signal-to-noise ratio (SNR) of optical signal 180. The high optical power of optical-probe beam 172 in block 910 may be significantly higher than the low optical power in block 908. After the optical power is set in block 910, method 900 may continue to block 902.

FIG. 10 is a block diagram illustrating lidar system 100 according to another embodiment. This particular embodiment of lidar system 100 implements multiple, partially redundant laser-safety features, e.g., by implementing circuit 110 using two processors, i.e., MPU 630 and an FPGA 10. The two processors can act complementarily and synergistically to implement a relatively sophisticated laser-safety response and failure mode detection. This embodiment of lidar system 100 includes many components and circuits already described above. Such components/circuits are labeled in FIG. 10 using the previously used reference numerals. For the description of those components/circuits, the reader is referred to the corresponding foregoing sections of this specification. The description of FIG. 10 focuses primarily on the features and/or circuits not previously described.

As shown in FIG. 10, lidar system 100 has an AC power adapter 1 connectable to an AC outlet. In operation, AC power adapter 1 generates a DC power supply, which is applied at least to optical scanner 166 and a laser power circuit 3. Laser power circuit 3 further converts the DC power supply into voltages/currents suitable for powering laser source 162 (FIG. 1). A power switch 2 can be operated, e g, manually, to connect and disconnect laser power circuit 3 to/from the DC power supply as needed. Power switch 2 can also be used as an emergency power switch. In an example embodiment, power system 130 (FIG. 1) may include one or more of AC power adapter 1, power switch 2, and laser power circuit 3 and may be further connected to provide electrical power to other electrical circuits, such as circuit 110 (FIG. 10), of lidar system 100.

In addition to optical scanner 166, lidar transceiver 160 includes a transceiver module 12, which includes, inter alia, laser source 162, optical receiver 168, and photodetector 250 (not explicitly shown in FIG. 10; see FIGS. 1, 2). The operability of optical scanner 166 is monitored using circuit 600 (also see FIG. 6). MPU 630 of circuit 600 is a part of electronic controller 110 (also see FIGS. 1 and 6). In addition to MPU 630, electronic controller 110 includes a field programmable gate array (FPGA) 30, which may include processing circuit 240 (not explicitly shown in FIG. 10; see FIG. 2). MPU 630 and FPGA 30 are configured to receive input signals from circuit 600 and lidar transceiver 160 as shown. FPGA 30 is further configured to generate control signals for transceiver module 12, as shown. Transceiver module 12 also has circuitry for providing various inputs to FPGA 30, with some of the inputs providing measurements of and/or settings for the laser driver current, optical power of the laser, temperature in one or more locations within lidar transceiver 160, etc. Optical scanner 166 similarly has circuitry for providing various inputs to MPU 630, with some of the inputs providing measurements for mirror position/angle feedback (FB), operating mode, etc. Optical scanner 166 may also communicate to MPU 630 a self-detected error, e.g., by way of an error indication signal. MPU 630 and FPGA 30 are further configured to control a laser power switch 20, as shown. Laser power switch 20 can be used, e.g., to perform operation 812b (FIG. 8). Various control signals generated by MPU 630 and FPGA 30 can be used to implement relevant portions of methods 800 and 900. For example, FPGA 30 may have a lookup table (LUT) 32 stored in a memory thereof, wherein permissible values of the optical power as well as PD-pulse time-interval values for different scan rates are specified. An exterior panel 40 of lidar system 100 has a plurality of various visual and audio indicators controlled by electronic controller 110.

According to an example embodiment disclosed above, e.g., in the summary section and/or in reference to any one or any combination of some or all of FIGS. 1-10, provided is an apparatus comprising: a lidar transmitter (e.g., 160, FIG. 1) including a laser source (e.g., 162, FIG. 1) to generate an optical-probe beam (e.g., 164, FIG. 1) and a movable mirror (e.g., 220, FIG. 2) to scan the optical-probe beam across a field of view (FOV) (e.g., 298, FIG. 2); an optical monitor (e.g., 140, FIG. 1) configured to generate a stream of measurements of a scan rate of the optical-probe beam by optically sensing motion of the movable mirror; and an electronic controller (e.g., 110, FIG. 1) configured to cause dynamic changes (e.g., at 812, FIG. 8; 908, 910, FIG. 9) of optical power of the optical-probe beam in response to the stream of measurements of the scan rate.

In some embodiments of the above apparatus, the apparatus further comprises a lidar receiver (e.g., 168, FIG. 1) to receive an optical signal (e.g., 180, FIG. 1) produced by reflections of the optical-probe beam from a scene (e.g., 198, FIG. 1) in the FOV; and wherein the electronic controller is configured to cause the lidar transmitter to dynamically change the optical power of the optical-probe beam such that maximum permissible exposure (MPE) for a person in the scene is not exceeded.

In some embodiments of any of the above apparatus, the electronic controller has a lookup table (e.g., 32, FIG. 10) stored in a memory thereof, the lookup table specifying permissible values of the optical power for different scan rates.

In some embodiments of any of the above apparatus, the lookup table further has stored therein information representing permissible parameter values (e.g., PD pulse intervals T, FIG. 7) of the stream of measurements for the different scan rates.

In some embodiments of any of the above apparatus, the electronic controller is programmed to control operations of the lidar transmitter in accordance with MPE values of an ANSI Z136.1 standard.

In some embodiments of any of the above apparatus, the electronic controller is configured to cause the optical power to be turned OFF (e.g., at 812b, FIG. 8) when the stream of measurements indicates that the movable mirror has stalled.

In some embodiments of any of the above apparatus, the optical monitor includes a photodetector (e.g., 250, FIG. 2) configured to measure the optical power of the optical-probe beam; and wherein the electronic controller (e.g., 110, FIG. 1) is further configured to cause the dynamic changes of the optical power based on a stream of measurements of the optical power received from the photodetector.

In some embodiments of any of the above apparatus, the optical monitor comprises: a plurality of photodiodes (e.g., PD1-PD4, FIGS. 4, 5, 6), each of the photodiodes being configured to generate a respective electrical pulse in response to the movable mirror directing light thereto; and an electrical circuit (e.g., 600, FIG. 6) connected to the photodiodes to generate an electrical pulse sequence (e.g., 622, FIG. 7) by combining the respective electrical pulses generated by different ones of the photodiodes; and wherein the electronic controller is configured to determine the scan rate based on the electrical pulse sequence.

In some embodiments of any of the above apparatus, the apparatus further comprises a light source (e.g., 202, FIG. 2) configured to shine the light (e.g., 204, FIG. 2) onto the movable mirror.

In some embodiments of any of the above apparatus, the light source is less powerful than the laser source.

In some embodiments of any of the above apparatus, the light and the optical-probe beam have different respective wavelengths.

In some embodiments of any of the above apparatus, the apparatus further comprises a plurality of diffuse reflectors (e.g., DR1-DR4, FIGS. 5A-5B), each one of the diffuse reflectors being configured to generate a respective cone of the light directed toward a respective (single) one of the photodiodes in response to the movable mirror directing at least a portion of the optical-probe beam to said one of the diffuse reflectors.

In some embodiments of any of the above apparatus, the optical monitor comprises a stripe-shaped, position-sensing photodetector (e.g., 410, FIG. 4E) configured to generate an electrical pulse sequence in response to the movable mirror repeatedly applying light thereto; and wherein the electronic controller is configured to determine the scan rate based on the electrical pulse sequence.

In some embodiments of any of the above apparatus, the apparatus further comprises a light source (e.g., 202, FIG. 2) configured to shine light (e.g., 204, FIG. 2) onto the movable mirror; and wherein the optical monitor comprises a two-dimensional, pixelated light detector (e.g., 230, 232, FIG. 2) configured to track the motion by capturing the light reflected by the movable mirror.

In some embodiments of any of the above apparatus, the apparatus further comprises a camera (e.g., 150, FIG. 1) configured to capture (e.g., at 904, FIG. 9) an image of a scene in the FOV; and wherein the electronic controller is configured to determine (e.g., at 906, FIG. 9) whether or not a person is present in the scene by processing the image and is further configured to cause the dynamic changes (e.g., at 908, 910, FIG. 9) based on a determination outcome.

In some embodiments of any of the above apparatus, the lidar transmitter includes circuitry (e.g., 12, 166, FIG. 10) configured to drive the laser source and further configured to drive the movable mirror, the circuitry being further configured to communicate to the electronic controller one or more performance indicators internally generated by the circuitry while driving the laser source and the movable mirror.

In some embodiments of any of the above apparatus, the one or more performance indicators include one or more of the following: a sensed laser-driver current; a sensed optical emit power of the laser source; sensed temperature in one or more locations within the lidar transmitter; mirror-orientation feedback; an operating mode setting; and an error indication signal.

According to another example embodiment disclosed above, e.g., in the summary section and/or in reference to any one or any combination of some or all of FIGS. 1-10, provided is a method of operating a lidar transmitter, the method comprising the steps of: scanning an optical-probe beam (e.g., 172, FIG. 1) across a field of view (FOV) (e.g., 298, FIG. 2) of the lidar transmitter by operating a laser source (e.g., 162, FIG. 1) and a movable mirror (e.g., 220, FIG. 2), the laser source being configured to apply the optical beam to the movable mirror (e.g., 220, FIG. 2); generating a stream of measurements (e.g., at 806, FIG. 8) of a scan rate of the optical-probe beam by optically sensing motion of the movable mirror; and dynamically changing (e.g., at 812, FIG. 8; 908, 910, FIG. 9) optical power of the optical-probe beam in response to the stream of measurements of the scan rate by operating an electronic controller (e.g., 30, 630, FIG. 10) connected to the laser source.

In some embodiments of the above method, the method further comprises: operating circuitry (e.g., 12, 166, FIG. 10) configured to drive the laser source and the movable mirror, the operating including the circuitry internally generating one or more performance indicators while driving the laser source and the movable mirror and externally communicating the one or more performance indicators to the electronic controller; and operating a camera (e.g., 150, FIG. 1) to capture (e.g., at 904, FIG. 9) an image of a scene in the FOV; and determining (e.g., at 906, FIG. 9) whether or not a person is present in the scene by automatically processing the image; and wherein said dynamically changing is performed further in response to the one or more performance indicators and based on a result of the determining.

While this disclosure includes references to illustrative embodiments, this specification is not intended to be construed in a limiting sense. Various modifications of the described embodiments, as well as other embodiments within the scope of the disclosure, which are apparent to persons of ordinary skill in the art to which the disclosure pertains are deemed to lie within the scope of the disclosure, e.g., as expressed in the following claims.

Some embodiments may be implemented as circuit-based processes, including possible implementation on a single integrated circuit.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature and principles of this disclosure may be made by those skilled in the pertinent art without departing from the scope of the disclosure, e.g., as expressed in the following claims.

The use of figure numbers and/or figure reference labels (if any) in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The description and drawings merely illustrate the principles of the disclosure. It will thus be appreciated that those of ordinary skill in the art will be able to devise various arrangements that, although not explicitly described or shown herein, embody the principles of the disclosure and are included within its scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

The functions of the various elements shown in the figures, including any functional blocks labeled as “processors” and/or “controllers,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and nonvolatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

As used in this application, the term “circuitry” may refer to one or more or all of the following: (a) hardware-only circuit implementations (such as implementations in only analog and/or digital circuitry); (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in machine-readable (e.g., non-transitory) medium and so executed by a computer or processor, whether or not such computer or processor is explicitly shown.

“SUMMARY OF SOME SPECIFIC EMBODIMENTS” in this specification is intended to introduce some example embodiments, with additional embodiments being described in “DETAILED DESCRIPTION” and/or in reference to one or more drawings. “SUMMARY OF SOME SPECIFIC EMBODIMENTS” is not intended to identify essential elements or features of the claimed subject matter, nor is it intended to limit the scope of the claimed subject matter.

What is claimed is:

1. An apparatus, comprising:
a lidar transmitter including a laser source to generate an optical-probe beam and a movable mirror to scan the optical-probe beam across a field of view (FOV);
an optical monitor configured to generate a stream of measurements of a scan rate of the optical-probe beam by optically sensing motion of the movable mirror; and
an electronic controller configured to cause dynamic changes of optical power of the optical-probe beam in response to the stream of measurements of the scan rate.

2. The apparatus of claim 1, further comprising a lidar receiver to receive an optical signal produced by reflections of the optical-probe beam from a scene in the FOV; and
wherein the electronic controller is configured to cause the lidar transmitter to dynamically change the optical power of the optical-probe beam such that maximum permissible exposure (MPE) for a person in the scene is not exceeded.

3. The apparatus of claim 2, wherein the electronic controller has a lookup table stored in a memory thereof, the lookup table specifying permissible values of the optical power for different scan rates.

4. The apparatus of claim 3, wherein the lookup table further has stored therein information representing permissible parameter values of the stream of measurements for the different scan rates.

5. The apparatus of claim 2, wherein the electronic controller is programmed to control operations of the lidar transmitter in accordance with MPE values of an ANSI Z136.1 standard.

6. The apparatus of claim 1, wherein the electronic controller is configured to cause the optical power to be turned OFF when the stream of measurements indicates that the movable mirror has stalled.

7. The apparatus of claim 1,
wherein the optical monitor includes a photodetector configured to measure the optical power of the optical-probe beam; and
wherein the electronic controller is further configured to cause the dynamic changes of the optical power based on a stream of measurements of the optical power received from the photodetector.

8. The apparatus of claim 1,
wherein the optical monitor comprises:
a plurality of photodiodes, each of the photodiodes being configured to generate a respective electrical pulse in response to the movable mirror directing light thereto; and
an electrical circuit connected to the photodiodes to generate an electrical pulse sequence by combining the respective electrical pulses generated by different ones of the photodiodes; and
wherein the electronic controller is configured to determine the scan rate based on the electrical pulse sequence.

9. The apparatus of claim 8, further comprising a light source configured to shine the light onto the movable mirror.

10. The apparatus of claim 9, wherein the light source is less powerful than the laser source.

11. The apparatus of claim 9, wherein the light and the optical-probe beam have different respective wavelengths.

12. The apparatus of claim 8, further comprising a plurality of diffuse reflectors, each one of the diffuse reflectors being configured to generate a respective cone of the light directed toward a respective one of the photodiodes in response to the movable mirror directing at least a portion of the optical-probe beam to said one of the diffuse reflectors.

13. The apparatus of claim 1,
wherein the optical monitor comprises a stripe-shaped, position-sensing photodetector configured to generate an electrical pulse sequence in response to the movable mirror repeatedly applying light thereto; and
wherein the electronic controller is configured to determine the scan rate based on the electrical pulse sequence.

14. The apparatus of claim 1, further comprising a light source configured to shine light onto the movable mirror; and
wherein the optical monitor comprises a two-dimensional, pixelated light detector configured to track the motion by capturing the light reflected by the movable mirror.

15. The apparatus of claim 1, further comprising a camera configured to capture an image of a scene in the FOV; and
wherein the electronic controller is configured to determine whether or not a person is present in the scene by processing the image and is further configured to cause the dynamic changes based on a determination outcome.

16. The apparatus of claim 1,
wherein the lidar transmitter includes circuitry configured to drive the laser source and further configured to drive the movable mirror; and
wherein the circuitry is further configured to communicate to the electronic controller one or more performance indicators internally generated by the circuitry while driving the laser source and the movable mirror.

17. The apparatus of claim 16, wherein the one or more performance indicators include one or more of the following:
a sensed laser-driver current;
a sensed optical emit power of the laser source;
sensed temperature in one or more locations within the lidar transmitter;
mirror-orientation feedback;
an operating mode setting; and
an error indication signal.

18. A method of operating a lidar transmitter, the method comprising:
scanning an optical-probe beam across a field of view (FOV) of the lidar transmitter by operating a laser source and a movable mirror, the laser source being configured to apply the optical beam to the movable mirror;
generating a stream of measurements of a scan rate of the optical-probe beam by optically sensing motion of the movable mirror; and
dynamically changing optical power of the optical-probe beam in response to the stream of measurements of the scan rate by operating an electronic controller connected to the laser source.

19. The method of claim 18, further comprising:
operating circuitry configured to drive the laser source and the movable mirror, the operating including the circuitry internally generating one or more performance indicators while driving the laser source and the movable mirror and externally communicating the one or more performance indicators to the electronic controller; and
operating a camera to capture an image of a scene in the FOV; and
determining whether or not a person is present in the scene by automatically processing the image.

20. The method of claim 19, wherein said dynamically changing is performed further in response to the one or more performance indicators and based on a result of the determining.
